(19) United States
(12) Patent Application Publication
(10) Pub. No.: US 2006/0256007 A1
(43) Pub. Date: Nov. 16, 2006

(54) Triangulation method and apparatus for targeting and accessing spatially associated information

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/344,701

(22) Filed: Jan. 31, 2006

Related U.S. Application Data
(63) Continuation-in-part of application No. 11/315,755, filed on Dec. 21, 2005.
(60) Provisional application No. 60/707,909, filed on Aug. 12, 2005.
(60) Provisional application No. 60/680,699, filed on May 13, 2005.

(51) Int. Cl. G01S 5/14; G01C 21/32; G01S 3/02; G08B 1/08

(52) U.S. Cl. 342/357.08; 342/450; 701/208; 340/539.11

(57) ABSTRACT

A method and apparatus is disclosed for enabling a user to target and access information that is associated with physical locations that are spatially distant from said user. More specifically, a method and apparatus is disclosed herein for enabling enhanced accuracy of spatial targeting and information access through a multi-step triangulation process. The methods and apparatus disclosed herein relate to portable information-targeting and information-accessing systems, such as a portable computing device interfaced with a positioning system such as the civilian Navstar Global Positioning System (GPS) in combination with a distributed network.

This application claims, under 35 U.S.C. § 119(e), the benefit of U.S. Provisional Application No. 60/707,909, entitled METHOD AND APPARATUS FOR ACCESSING OF DISTANT SPATIALLY-ASSOCIATED INFORMATION, filed Aug. 12, 2005, (Attorney Docket No 3502.021) by Rosenberg, which is incorporated in its entirety herein by reference.

This application is a continuation in part, under 35 U.S.C. § 120, of U.S. patent application Ser. No. 11/315,755 (Attorney Docket No 3502.016), entitled METHOD AND APPARATUS FOR ACCESSING SPATIALLY ASSOCIATED INFORMATION as filed Dec. 21, 2005, by Rosenberg, which also claims benefit under 35 U.S.C. § 119(e) to U.S. Provisional Application No. 60/680,699, entitled DATASCOPE INTERFACE FOR ACCESSING DISTANT SPATIALLY ASSOCIATED INFORMATION, filed May 13, 2005, (Attorney Docket No 3502.015) by Rosenberg, which are incorporated in their entirety by reference.

### CROSS REFERENCE TO RELATED APPLICATIONS

None

### FEDERALLY SPONSORED RESEARCH

None

### BACKGROUND

1. Field

The present invention in some embodiments relates to the field of information stored and accessed based upon spatial locations in a geographic environment. More specifically, these embodiments relate to obtaining information relating to an identified spatial location using a positioning system interfaced to a portable computing device. Specifically, these embodiments relate to a system and methods for obtaining location specific information about a particular identified location that is some distance away from the location at which the user is currently standing using a distributed network in combination with a GPS enabled portable computing device, said embodiments involving a multi-step triangulation process as well as targeting and prioritization methods and technology.

2. Discussion of the Related Art

The embodiments described herein relate to the field of information stored and accessed based upon spatial locations in a geographic environment. Such systems are described in the paper by Spohrer entitled “Information in Places” and published in IBM Systems Journal, vol. 38, No. 4, 1999 (p. 602-628) which is hereby incorporated by reference. More specifically, the present embodiments relate to obtaining information relating to an identified spatial location using a positioning system interfaced to a portable computing device. Even more specifically, the present embodiments relate to obtaining information relating to an identified spatial location that is some distance away from the location at which the user is currently standing. Even more specifically, the present embodiments relate to a system and methods for obtaining location specific information about a particular identified location that is some distance away from the location at which the user is currently standing using a distributed network in combination with a GPS enabled portable computing device, said embodiments involving a unique multi-step triangulation process as well as unique targeting and prioritization methods and technology.

A number of systems have been developed for accessing location related information, said location related information being accessed based upon the then current location of said portable computing system as determined by one or more Global Positioning System (GPS) sensor local to a computing system. For example, U.S. Pat. No. 6,122,520 entitled “System and method for obtaining and using location specific information” and hereby incorporated by reference, describes a system that uses Navstar Global Positioning System (GPS), in combination with a distributed network, to access location related information based upon GPS coordinates. In addition U.S. Pat. No. 6,819,267 entitled System and method for proximity bookmarks using GPS and pervasive computing and hereby incorporated by reference, also describes a system for accessing location related information using GPS coordinates. In addition U.S. Patent Application 20050032528 entitled “Geographical web browser, methods, apparatus and systems” and hereby incorporated by reference, also describes a system for accessing location related information using GPS coordinates.

The problem with such systems is that a user often wants to gain information about a location that they are not local to, but which is off in the viewable distance to that user. For example, a user may be standing on a street corner and is looking at a building that is a few hundred yards away and may desire information about that building. Or a user may be standing in a park and is looking at a tree that is a hundred feet away and may desire information about that tree. Or a user may be standing on a hilltop vista looking at a lake that is two miles away and may desire information about that lake. In addition, the distant object that the user may desire information about may be near many other objects that also have information associated with them based upon their geographic location. What is needed is a convenient and easy to use method by which a user can identify a target geographic location that is off in the viewable distance to that user, differentiate that target location from other nearby geographic locations, and selectively access information associated with the desired target location. One approach has been disclosed by the current inventor in aforementioned pending U.S. Provisional Patent Application No. 60/680,699 that addresses this need. The current embodiments, as disclosed herein, provides a potentially less expensive and more accurate solution by employing a multi-step triangulation process.

As disclosed in pending U.S. Provisional Patent Application 60/680,699, an user interface device and method has been developed and is referred to herein as a Datascope that allows a user gather information about a distant location (or an object at that distant) by pointing a portable computing device at that location. Because numerous objects can be located within the aim of the user, a number of novel methods have been developed for designating the desired direction and distance of the target object. In one embodiment the Datascope device includes a scroll wheel by which a user can scroll near or far and selectively access information about locations/objects at different distances from the user. In another embodiment the Datascope device includes a range-finding sensor such as a laser range finder or ultrasonic range finder for selectively accessing information about locations/objects at different distances from the user. In other embodiments the Datascope includes an optical focusing sensor mechanism for selectively accessing information about locations/objects at different distances from the user. In other embodiments the Datascope includes a triangulation mechanism for selectively accessing information about locations/objects at different distances from the user. The present embodiments offer an improvement referred to herein as a multi-step triangulation process that can be used instead of, or in combination with, the methods and apparatus disclosed previously, to reduce the cost and/or improve the accuracy of remote targeting and remote accessing of spatially associated information.

Overview

Many people travel about the world without realizing the large amount of information concerning their surroundings. For example, people travel in their own communities without knowing what buildings and monuments may be of historical significance or what shopping center may have a specific store or whether any store in the shopping center sells a specific product. In addition the natural world is filled with location-related information that is of interest to people—the names of particular trees, plants, landforms, bodies of water, and other natural landmarks that are fixed in location.

In many instances, people rely on maps, field guides, brochures or other literature in order to familiarize themselves with their local surroundings. These documents may include tourist/travel brochures, shopping mall directories/maps, park field guides or naturalist books, or other similar literature. However, these documents are not very informative because they contain limited amounts of information and are generally not useful on the fine identification of objects such as specific trees and plants. Also such printed information is generally not kept up to date as well as on-line information. In addition, such information is not always easy to relate to the real physical surroundings in which a user is located. For example, field guide may refer to a tree that is a few hundred yards off a particular trail. The user may find it difficult to know which of numerous trees located in that general direction the field guide is referring to.

Another problem with printed field guides and brochures is that they are difficult to update, providing information that may be old or incomplete. For example, a field guide might refer to a plant or tree that recently died and is no longer present in the environment. Or the field guide may fail to refer to a plant or tree that has just emerged. In addition, users can take their own personal notes on field guides and brochures to note changes or make additional comments, but such notes can not be easily shared among other users. What is clearly needed is a more interactive method of accessing and/or updating and/or providing information related to particular spatial location and/or object at a particular spatial location.

This lack of information and/or difficulty in updating information often results in ineffective advertising for businesses and limited scientific information about natural phenomenon. For example, on a traditional map or brochure covering a city, business are not be able to provide the consumer with a list of products sold in a particular store nor can businesses indicate products that are currently on sale or otherwise featured. On a traditional map or guide covering a park, information can not be given that identifies the type and age and factual information associated with individual trees. Similarly, a local historical building may not be able to provide the public with detailed historical information concerning the significance of the site or any new information such as upcoming events at that location.

However, many entities, such as stores, parks, historical sites, and/or businesses now utilize distributed networks, such as the Internet and, more particularly, the World Wide Web portion of the Internet, to provide the public with useful information. For example, information about a historical site, such as a Civil War battlefield, may be disseminated via the World Wide Web and accessed though commercial Internet service providers (ISPs). The World Wide Web also provides the public with countless amounts of other information, such as business data, stock quotes or official government information.

However, a user will not have access to the desired information unless they manually input a web address or uniform resource locator (URL) associated with a particular web page. In these cases, it may be difficult to retrieve the web page because the URL may be unknown or difficult to locate, even with the sophisticated search engines currently available. Also, the web address may be very long which may result in a mistake when entering the web address. Also in many cases the user may be at a location and looking at an object in the distance, such as a tree or building or river or lake or hill or valley or outcropping of rock and may not know what kind of tree it is, what building it is, what the name or the river is, what the name of the lake is, how tall the hill is, what the name of valley is, or what kind of outcropping of rock. All the user may know is that the object is located within their field of view, some distance away at a particular orientation. In such a circumstance the user may not know how to search for a URL that would provide information about the particular tree or building or river or lake or hill or rock other object that they are then looking at and wondering about.

As mentioned above, a number of systems have been developed to link a GPS location with factual information on the internet such that the information can be retrieved by a user who is using a portable computing device interfaced with a GPS sensor by standing at a given location. What is needed, however, the ability to enable a user to identify a particular location (or object at a location) other than the location the user is standing. This is a critical need because a user may not desire information about his or her current GPS location but rather may desire to identify a GPS location (or object at a location) that is some distance away in a particular direction. For example a user may be standing on a hilltop, looking a lake in the distance. That lake is not at the user's current GPS location, but at some other location in the distance. What is clearly needed are methods and apparatus that allow a user to conveniently identify an object at a distance in a direction from the user and distinguish that object from other nearby objects and then retrieve information about that distant object. Furthermore what is needed are methods and apparatus that are of reduce complexity and/or cost of the required hardware devices. Furthermore that is needed are methods and apparatus that enable increase targeting accuracy of distant objects. Furthermore what is needed are methods and apparatus that enable a user to increase his or her accuracy at will by performing additional steps.

### SUMMARY

The present invention in some embodiments consists of a method for retrieving information that is relationally associated with a distant location in a physical environment using a portable computer as a targeting device. Specifically, the portable computerconsists of a hand-held device with a wireless interface that is connected to a distributed network that contains a database of information based on spatial locations. An example of such a distributed network is the Internet.

The method consists of a multi-step triangulation process to more accurately identify the distant location for which information is to be retrieved. One embodiment of the multi-step triangulation process involves targeting the distant location a plurality of times each time from separate position within the physical environment. Each time the distant location is targeted from a separate position within the physical environment, a positional coordinate and directional vector are collected that describe the aiming position and aiming orientation of the handheld computing device for that targeting step. A plurality of such positional coordinates and directional vectors are used in combination to more accurately identify the distant location for which information is be retrieved. The retrieved information is then displayed upon the screen of the handheld device.

This method can be used in combination with object type and/or object context type filters to reduce the amount of information and/or to more accurately specify the information that is to be retrieved and/or displayed. Furthermore the portable computer may incorporate one or more targeting components for aiding the user in targeting the distant location. One such targeting component is a laser pointer. Another such targeting component is a camera.

### BRIEF DESCRIPTION OF THE DRAWINGS

FIG. 1 shows a portable computing device configured with appropriate hardware and software to support the embodiments disclosed herein FIG. 2 is a system block diagram of the portable computing device, the GPS system and the distributed network.

FIG. 3 shows a portable computing device configured with a laser pointer for use in targeting remote locations with increased accuracy.

FIG. 4 shows the portable computing device in two positions to demonstrate the multi-step process for triangulation.

FIG. 5 shows a portable computing device equipped with an integrated digital camera and a internal identification system.

FIG. 6: shows an embodiment of the present invention equipped with a camera and display for use as a targeting tool.

### DETAILED DESCRIPTION

The following description is not to be taken in a limiting sense, but is made merely for the purpose of describing the general principles of exemplary embodiments. The scope of the invention should be determined with reference to the claims.

Operational Overview

The present embodiments enable a user to access information associated with a distant spatial location (or a distant spatial area) by pointing a handheld computing device at that distant location (or distant area) from a plurality of different local locations. As used herein, the term “distant location” refers to a spatial location within the user's environment that is located some distance away from the place that the user is standing. In practical terms, a distant location is a location that is far enough away from the user or inconvenient enough to access that it does not make sense for the user to simply walk over and hold the personal computing device at or near that location. Similarly, as used herein, the term “distant area” refers to a spatial area and/or a range of spatial locations within the user's environment that is located some distance away from the place that the user is standing. In practical terms, a distant area is an area of some defined size that is far enough away from the user or inconvenient enough to access that it does not make sense for the user to simply walk over and hold the personal computing device at or near that area. Also, as used herein the term “local location” refers to a spatial location within the user's environment that the user accesses by standing at or substantially near that location while holding said personal computing device. Note, in some typical cases a distant location (or area) is a location (or area) that is far from the user, for example between 20 feet and 2,000 feet away. In some cases it may be closer than that range, in other cases it may be farther. For example, in some common embodiments a distant location may be only a few feet away but may be located off a path or trail in a place the user can not easily access or may be located off the ground at a height that a user can not easily reach.

The present embodiments employ a portable computing device interfaced with a positioning system such as the Navstar Global Positioning System (GPS) in combination with a distributed network, such as the Internet, to provide real-time location specific information to a user. The embodiments include a wireless transceiver for communicating to the distributed network. The GPS sensor generates a coordinate entry that relates to the then current location of the portable computing device. A multi-step triangulation process (and supporting apparatus) is then used to identify a location (or area) that is some distance away from the then current location of the portable computing device as identified by the user of said portable computing device, said multi-step triangulation method allowing said user of said portable computing device to target a specific distant location or a specific distant area that is a particular direction and distance away from said then current location of the portable computing device. Said specific distant location or said specific distant area is then transmitted as data to the distributed network, either directly or as a coded representation, for retrieval of corresponding location specific information. The location specific information may reside on a web page. Location coordinates may be incorporated into the web page address or may be linked to the web page, associating that web information with a particular location or a particular range of locations in the physical world. If the particular location or range of locations for a particular piece of web information is the same as said specific distant location, falls within a range of locations identified by said specific distant area, or is within a certain proximity of said specific distant location or said range of specific distant locations, that information is accessed and transmitted to said portable computing device. Additional information may be associated with the web page such as priority information, category information, and/or weighting information. Optionally contingent upon said priority information, category information, and/or other conditional information, the web page and associated information is then displayed to the user. Note—in some embodiments, said priority information, category information, and/or other conditional information is used to limit what information is transmitted over said network to said portable computing device so as to reduce communication burden.

The methods and apparatus of the inventive system operate in a series of steps as follows:

In the first step (Step I), the user resides at a first local location and points the portable computing device at a desired distant location or desired distant area. The act of pointing, referred to herein as “targeting” may be performed with the aid of one or more inventive targeting tools that will be described in detail later in this document. When the portable computing device is appropriately aimed at said desired distant location or desired distant area, the user engages a user-interface element to indicate to the software running upon said portable computing system that the device is appropriately aimed. In the most basic embodiment, the user-interface element is a physical button pressed by the user when said portable computing device is appropriately aimed at said desired distant location or desired distant area. In other embodiments said user-interface element may include a knob, lever, slider, roller, or other physically manipulatable element. In other embodiments said user-interface element may include a graphical element within a displayed graphical user interface. In some embodiments said user-interface element may include a touch screen. In some embodiments said user-interface element may include a vocal command issued to a voice recognition system. In some embodiments, said user-interface element may include more exotic means of conveying user intent to a computer system such as an eye-tracking system, a gesture recognition system, or an electro-neural interface. Regardless of what type of user interface the user engages, once the user indicates by button press or otherwise that the portable computing device is appropriately aimed, the second step of the process is engaged (referred to herein as Step II).

In one embodiment, the portable computing device is (or includes) a handheld unit, as will be described in detail later in this document, that can be freely aimed by the user at a target remote location in space. In some embodiments, said portable computing device is fully or partially head-mounted and is aimed by said user as a result of the user looking in a particular direction. A variety of inventive aiming tools and methods (referred to herein as “targeting tools”) can be employed to assist the user in targeting desired distant locations and/or desired distant areas, for example a laser pointer may be used upon or within said portable computing device (or an aimable portion thereof) and aid targeting by displaying a distant red dot at the first intersected location at which the user is aiming. Alternately an image of the remote space captured by a digital camera upon or within said portable computing device may be displayed to the user with overlaid crosshairs to aid targeting. These targeting tools will be described in more detail later in this document.

In the second step (Step II), position and orientation sensors local to a portable computing device are used to determine the current local location of the user and the current direction that the portable computing device is aimed. Said position and orientation sensors include for example a GPS sensor and a supplemental orientation sensors such as an accelerometer and/or magnetometer as will be described in more detail later in this document. The reading and processing of said sensors by software running on said portable computing device provides a positional coordinate and directional vector for said portable computing device as it is positioned by the user at said current local location and in said current direction. In some preferred embodiments, the positional coordinate is a GPS location coordinate accessed from a GPS sensor that is incorporated into and/or interfaced with said portable computing device. In some such embodiments said GPS sensor is integrated within the housing of said portable computing device. In other such embodiments said GPS sensor is external to said portable computing device and held or worn locally by said user as said user stands at said current local location. In all such embodiments said GPS sensor (or other positional sensor) is in communication with said portable computing device, conveying positional information to said portable computing device about said current local location. In some preferred embodiments the directional vector is a spatial orientation value accessed from a magnetometer sensor that is incorporated into and/or interfaced with said portable computing device. In some such embodiments said magnetometer sensor is integrated within the housing of said portable computing device such that it detects the orientation of said portable computing device when it is aimed at said desired distant location and/or at said desired distant area. In such embodiments said directional vector is a spatial orientation value pointing in a direction from said current local location to said desired distant location and/or desired distant area. In other such embodiments said magnetometer sensor is external to said portable computing device and is held or worn by said user in a pointing portion of said system that is aimed by said user at said desired distant location and/or at said desired distant area. In such embodiments said directional vector is a spatial orientation value pointing in a direction from said current local location to said desired distant location and/or desired distant area. In all such embodiments said magnetometer sensor (or other orientation sensor) is in communication with said portable computing device, conveying directional information to said portable computing device about the direction from said current local location to said desired distant location and/or desired distant area.

Thus reviewing Step I and Step II together, the portable computing device is aimed by said user at a desired distant location or a desired distant area when said user is standing at a current local location. When the user achieves the desired aim, the user presses a button, performs a gesture, utters a phrase, or otherwise indicates to the user interface of the system that the device is aimed as the user desires. Based upon said button press or other indication by the user that the device is currently aimed at a desired target, the software running upon the portable computing device reads said position and orientation sensors to determine current positional coordinates and a current directional vector. The current positional coordinates are spatial coordinates, such as GPS coordinates, that represent the current local location. The current directional vector is an orientation vector that points in a direction from said current local location to said desired distant location and/or desired distant area. The current positional coordinates and current directional vector are then stored in memory local to said portable computing device and assigned variable name identifiers such that they can be later retrieved. For convenience, this first set of current positional coordinates is referred to herein as first positional coordinates and this first directional vector is referred to herein as a first directional vector. Similarly for convenience, the current local location used thus far is referred to herein as the first local location. These names are given herein to distinguish these values from other coordinates and vectors as to be described in the following steps.

At this point in the process the data stored in memory comprising said first positional coordinates and said first directional vector, when taken together, mathematically define a line extending from said first local location through said desired distant location and continuing infinitely beyond. Unfortunately this data does not specifically define or identify said desired distant location. This is because there is no way to know where upon said infinite line the desired distant location resides. Additional information is needed. To provide this additional information, the multi-step triangulation process is employed by proceeding through the following additional steps.

In the third step (Step II), the user moves to a new local location within the user's local environment, said new location not being a location along said infinite line described previously and preferably not being substantially near to said line. As used in this step, “substantially near” is a value that is less than 10% of the total distance from said first local location to said desired distant location (or desired distant area). Said new local location is referred to herein as a second local location and is preferably a location from which the user can get a clear line-of-sight targeting of said desired distant location (or desired distant area). Now standing at said second local location, the user points the portable computing device (or a portion thereof) at said desired distant location and/or desired distant area. When the portable computing device is appropriately aimed at said desired distant location (or desired distant area), the user engages a user-interface element to indicate to the software running upon said portable computing system that the device is appropriately aimed. Based upon a button press or other indication by the user that the device is currently aimed at a desired target, the software running upon the portable computing device reads said position and orientation sensors to determine current positional coordinates and a current directional vector. The current positional coordinates are spatial coordinates, such as GPS coordinates, that represent the second local location. The current directional vector is an orientation vector that points in a direction from said second local location to said desired distant location and/or desired distant area. The current positional coordinates and current directional vector are then stored in memory local to said portable computing device and assigned unique variable name identifiers such that they can be later retrieved. For convenience, this second set of current positional coordinates is referred to herein as second positional coordinates and this second directional vector is referred to herein as a second directional vector.

In the fourth step (Step IV) is the determination of distant target coordinates for said desired distant location (or desired distant area) through a mathematical triangulation process. This is performed as follows: the first positional coordinates and the first directional vector, when taken together, mathematically define a line extending from said first local location through said desired distant location and continuing infinitely beyond. Similarly, the second positional coordinates and the second directional vector, when taken together, mathematically define a line extending from said second local location through said desired distant location and continuing infinitely beyond. In theory these two lines will intersect at a single point that mathematically defines said desired distant location. This is unlikely to happen for it would require that the user aimed perfectly at the exact same location in space when targeting from each of said first local location and said second local location. In reality these two lines will not actually intersect, but will come near each other, assuming the user aimed with reasonable skill. Thus there will be a single point that is mathematically the nearest to both lines and that point will be a good approximation of the desired distant location that the user was aiming at. Thus by solving for the set of coordinates that comes the closet to falling upon both lines, the desired distant location can be determined within a reasonably small margin of error. This can be computed mathematically by first finding the shortest line segment that exists with one end of said line segment upon one of said infinite lines and the other end of said line segment upon the other of said infinite lines, then computing the midpoint of that line segment. This point is the best-fit intersection point for said two infinite lines. The coordinates of this best-fit intersection point can thus be used as a good approximation of said desired distant location. This is achieved by assigning said distant target coordinates as the coordinates of the best-fit intersection point.

If a desired distant area is desired, a range of values around the best-fit intersection point is defined. In a preferred embodiment, a circular area is defined by assigning the distant target coordinates as the best-fit intersection point and a radius length, the radius length defining the radius of the circle centered about the best-fit intersection point and falling within the plane defined by said two lines. In some embodiments a desired distant volume is desired. This is defined as a volumetric range of values around said best-fit intersection point. In a preferred embodiment a spherical volume is defined by assigning said distant target coordinates as said best-fit intersection point and a radius length, the radius length defining the radius of a sphere centered about the best-fit intersection point. Other shapes of areas and volumes can be defined about the best-fit intersection point or offset from the best-fit intersection point.

In the fifth step (Step V) it is necessary to cross-reference the distant target coordinates with stored internet information that is cataloged with respect to location information. In the preferred embodiments this information is cataloged based upon geographic coordinates (e.g., specific latitude and longitude coordinates) and so the step of cross referencing involves determining which web sites (or other internet information) are associated with specific geographic coordinates that fall within a particular proximity of the distant target coordinates and fall within the defined area (or volume) represented by the distant target coordinates.

In some embodiments of the present invention, the third step (Step III) may be repeated a one or more additional times. Each time this step is repeated, the user moves to a new local location within the user's local environment, said new location not being a location along any of the previously defined infinite lines and preferably not being substantially near to any said lines. The first time the third step (Step II) is repeated, said new local location is referred to herein as a third local location. The next time the third step (Step II) is repeated, the new local location is referred to herein as a forth local location. This pattern continues, defining fifth, sixth, seventh, etc. local locations for each repetition of Step III respectively. For each repetition of Step II, the user will stand at the new local location and point the portable computing device (or a portion thereof) at the desired distant location and/or desired distant area. When the portable computing device is appropriately aimed at the desired distant location (or desired distant area), the user engages the user-interface element to indicate to the software running upon the portable computing system that the device is appropriately aimed. Based upon a button press or other indication by the user that the device is currently aimed at a desired target, the software running upon the portable computing device reads the position and orientation sensors to determine current positional coordinates and a current directional vector. The current positional coordinates are spatial coordinates, such as GPS coordinates, that represent the new local location. The current directional vector is an orientation vector that points in a direction from the new local location to said desired distant location (or desired distant area). The current positional coordinates and current directional vector are then stored in memory local to the portable computing device and assigned unique variable name identifiers such that they can be later retrieved and used in computations. For convenience, each subsequent set of current positional coordinates is referred to herein as third positional coordinates, forth positional coordinates, fifth positional coordinates, etc. . . . Similarly, for convenience each subsequent set of current directional vectors are referred to herein as the third directional vector, forth directional vector, fifth directional vector, etc. . . . In this way, the user can repeat the third step (Step II) any number of times, each time moving himself to a new local location, aiming at said same desired distant location (or desired distant area) from that new local location, and store a new set of positional coordinates and directional vector for that iteration.

Other embodiments of the present invention are configured to allow the user to repeat the third step (Step II) any number of times prior to proceeding to the fourth step (Step IV). Once proceeding to Step IV a triangulation is performed using all the data collected in the repeated iterations of the third step (Step II). In this way, the user by performing multiple iterations of third step (Step II) can achieve more accurate results when solving the intersection equations in the fourth step (Step IV). In such embodiments statistical averaging techniques can be used to determine a single best-fit intersection point among the plurality of infinite lines.

Some embodiments perform the calculations of the fourth step (Step IV) between each iteration of the third step (Step II) and give the user feedback as to how accurate of a best-fit-intersection point has been achieved. For example, if the user has performed two targeting steps and defined in memory two infinite lines that only come within 6.2 feet of each other at their nearest point, this 6.2 foot distance (or a representation thereof) is displayed to the user to indicate to him or her how precise the current targeting actions are. If the user is trying to aim at something that is substantially smaller than 6.2 feet, for example a single tree among a number of other trees, the user can optionally elect to perform another iteration of the third step (Step II) (i.e. going to a new local location and re-targeting the desired distant location) thereby collecting data defining another infinite line the fourth step (Step IV) is then repeated using the additional infinite line, computing a new best-fit intersection point. The user is again given feedback as to the accuracy of the new best fit intersection point.

System Overview

The hardware-software system, which may be generally referred to as a “targeting location-information system,” is preferably a portable computing device such as a portable computer or similar processor driven portable device such as personal digital assistant (PDA), portable media player, portable digital telephone, portable gaming system, or processor enabled wristwatch. In many preferred embodiments, the portable computing device includes a casing having a physical shape with a defined pointing end and/or pointing portion for use in aiming at a target, an internal microcontroller, a wireless communication link such as an RF transceiver, position and orientation sensors which are connected to the microcontroller, and a power supply (e.g., batteries) for powering these electronic components. The portable computing device may also include other electronic components such as a user activated switches or buttons or levers or knobs or touch screens or microphones or speakers or LCD displays or lights or graphical displays. These components, which are also connected to the microcontroller, are employed for the purpose providing information display to users and/or for allowing the user to provide input to the system. These input and output components are collectively referred to as the User Interface (UI) of the portable computing device.

The portable computer or other processor driven portable device includes targeting apparatus such that it can be aimed at a distant target by the user, the user interacting with a user interface upon the device to indicate when said distant target is aimed. The targeting apparatus may be integrated into the main enclosure of said portable computing device or may be in a separate aimable portion that is in communication with a processor of said portable computing device. The portable computer or other processor driven portable device also includes a wireless connection to a computational network such as the Internet and is connected to a local geographic sensing system including for example a GPS sensor and preferably other sensors such as an accelerometer and/or magnetometer. When the portable computer or other processor driven portable device is aimed at a distant target, signals from the sensors are used to determine current positional coordinates and a current directional vector for said portable device. The targeting apparatus is used to support the aiming process. The targeting apparatus may include digital cameras, laser pointers, or other targeting aids. Regardless of the targeting apparatus used, a number of targeting steps are performed by the user to collect the targeting lines. These targeting lines are used to mathematically compute a best-fit intersection point (or area) that is represented in a computed set of distant target coordinates. These distant target coordinates are transmitted to a server on the distributed network. The target coordinates may be combined with a URL to make a unique URL that references a web page on a predetermined server for a particular web page that describes that location. The target coordinates may also, for example, link to an existing web page on the distributed network associated with those coordinates. The web page and associated information, such as historical information, local areas of interest, tree information, hill information, lake information, shopping centers and the like, are transmitted to the portable computing device and displayed to the user.

For cases wherein multiple sets of information are associated with the current distant target coordinates, a prioritization method is employed that orders how the information is displayed to the user upon the portable device based upon one or more criteria. The criteria may include information about how near of a spatial match the web information is to the distant target coordinates, that web information that is nearest to a specific set of distant target coordinates and/or most centrally located within a range of distant target coordinates are given higher priority. In some embodiments content related criteria are used in addition to, or instead of, spatial location related criteria to prioritize, order, and/or filter the information that is displayed to the user. The content related criteria may include, for example, a Targeting Context Type that indicates the general context within which the user is performing the location related information search. The Targeting Context can be defined, for example, as one or more general search contexts such as—Consumer, Educational, Historical, or Natural. In this way, if the user had selected Natural as his Targeting Context Type, only data relating to natural objects such as trees and hills and bodies of water, would be displayed and/or would be displayed with higher priority than other data. Said content related criteria may also include a Targeting Object Type that indicates the type of object the user desires information about when performing the location related information search. The Targeting Object Type can be defined, for example, as one or more object types such as Trees, Plants, Buildings, Landforms, Bodies of Water, Bridges, Stores, Foliage, or Historical Landmarks. Said content related criteria may also include a prioritization rating that gives priory to certain web links based upon their popularity, their importance, or a paid priority fee. In preferred embodiments, the Targeting Context Type and the Targeting Object Type are user definable through a user interface upon the portable computing device.

As an example, a user might target a tree that is on a hill and right in front of a historic barn. In this example all three of the tree and the hill and the barn have information stored in the internet about them linked to the same or similar geographic coordinates. As part of the targeting process, the user repeatedly aims his portable computing device at the tree on the hill that is in front of the barn and indicates through the user interface that he or she is looking for information about a target of the Targeting Object Type equal to Foliage. Based upon this Targeting Object Type entered by the user the information is accessed and displayed for the tree, but not for the hill or the barn. Had there been multiple objects of type foliage within the range specified by the user, each of the multiple objects of foliage having location specific information linked to it with similar location addresses, information about those multiple objects of foliage may all be presented to the user, ordered based upon available prioritization information and/or ordered based on proximity to the user and/or proximity to said best-fit intersection point. For example if a tree that is a particularly popular object to be targeted by users is located next to a common shrub that is very rarely targeted by users, both with internet information linked to the same or similar location, priority information may also be linked to those objects, in this case assigning higher priority to the tree than the shrub based upon its historical frequency of being targeted by users. The portable computing device, upon accessing the location specific information, the information including factual information about the foliage and priority information about the objects, displays the factual information ordered based upon the priority information—displaying the factual information about the tree first on a displayed list and displaying the factual information about the shrub second. Alternatively, the portable computing device may prioritize alone, or in combination with other information, based upon which object is closer to the user and/or which object is closer to said distant target coordinates or said range of distant target coordinates.

Important to the present embodiments are targeting tools which aid the user in aiming the portable computing device (or an aimable portion thereof) at a desired distant location (or area). In some embodiments, the targeting tools include a digital video camera that is aimed by the user at the desired distant location such that an image from the video camera is displayed to the user upon a display on the portable computing device. In some embodiments the image displayed upon said portable computing device includes overlaid cross-hairs or some other graphical indicator that indicates the particular targeting location (or targeting area) of the portable computing device as aimed by the user at a desired distant location. In other embodiments the targeting tools include a laser pointer that can be aimed by the user at the specific remote location.

As described previously, the various embodiments include a portable computing device capable of interfacing with a remote network through a wireless connection and access location specific information from that network based upon what that portable computing device is being aimed at as determined in part from a plurality of locations and orientations of the device at times when the device is successfully aimed. In preferred embodiments, the portable computing device includes a radio frequency (RF) transceiver for accessing said remote network such as the Internet. It should be noted that other bi-directional communication links can be used other than or in addition to RF. In some preferred embodiment a Bluetooth communication link is used to allow bidirectional communication to and from the portable computing device and said remote network.

Distributed networks, such as the Internet and other private and commercial distributed networks are a source of useful information. This information varies from advertisements to educational information to business data to encyclopedic information. This information is typically resident on a particular web page having a unique URL or address that is provided on the World Wide Web, for example. For a user to obtain this information, the user either enters into the computer a unique URL for retrieving the web page or certain keywords in order to search for the web page using well-known search engines.

Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the embodiments herein. However, other positioning systems are also contemplated for use with the present invention.

In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In order to gain orientation information, one or more sensors may be included within or affixed to or otherwise connected to the portable computing device. Some said sensors can provide tilt information with respect to the gravitational up-down direction. Other sensors can provide orientation information with respect to magnetic north. For example an accelerometer if included in many embodiments to provide tilt orientation information about the portable computing device in one or two axes. In some embodiment a single axis accelerometer is used that senses the pitch angle (tilt away from horizontal) that the portable computing device is pointing. In other embodiments a 2-axis accelerometer may be used that senses the pitch angle (tilt away from horizontal) that the portable computing device is pointing as well as the roll angle (left-right tilt) that the portable computing device is pointing. A suitable accelerometer is model number ADXL202 manufactured by Analog Devices, Inc. of Norwood Mass. To sense the orientation of the portable computing device with respect to magnetic north, a magnetometer is included. In one embodiment a 3-axis magnetometer model number HMC1023 manufactured by Honeywell SSEC of Plymouth, Minn. is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the portable computing device. The orientation sensor may all be housed within the casing of the portable computing device and be connected electronically to the microprocessor of the portable computing device such that the microprocessor can access sensor readings and perform computations based upon and/or contingent upon said sensor readings. In other embodiments, the orientation sensors may be housed within an external housing that is enclosed within the portable computing device, the external housing configured to be easily held or worn by the user. As used herein, the external housing although physically separate from the main housing of the portable computing device is considered a portion thereof so long as it remains local to the user as the user moves about his or her environment while performing the methods of the present embodiments.

Overview of the Drawings

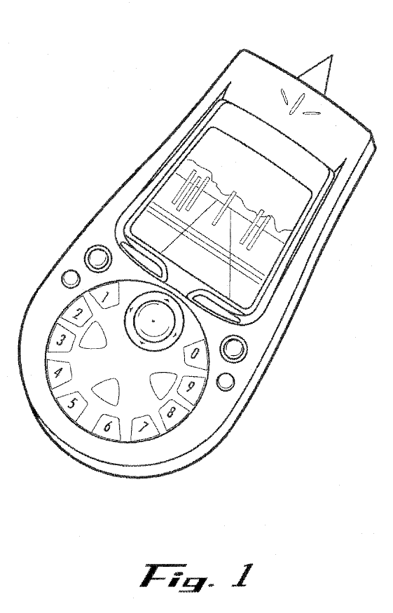

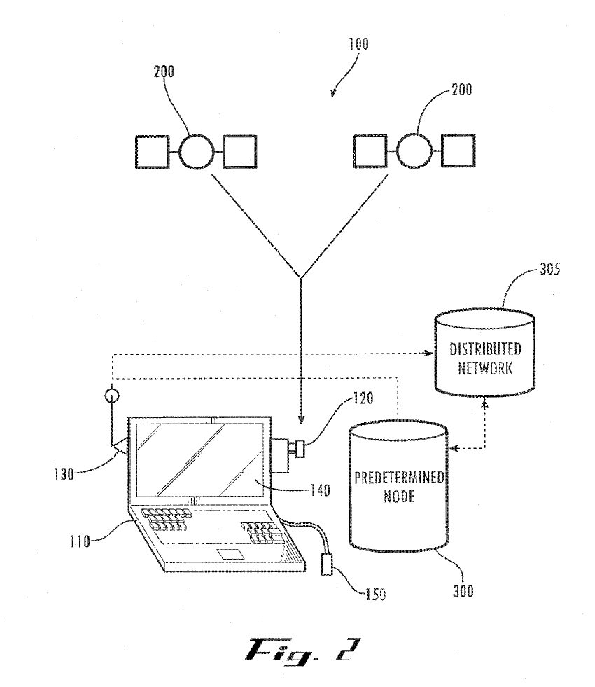

As shown in FIG. 1, a portable computing device configured with appropriate hardware and software to support the embodiments disclosed herein. Said portable computing device includes a computer processor, an information display, a user interface, and a wireless communication link to an information network such as the Internet. The portable computing device also includes a differential GPS transceiver for sensing the geographic location of the portable computing device with a high degree of accuracy. The portable computing device also includes one or more orientation sensors such as a magnetometer for sensing geometric orientation with respect to geographic north and an accelerometer for sensing pitch angle of the device with respect to the gravitational horizontal when aimed at a desired distant location. Also the portable computing device is shaped such that it can be conveniently pointed at a distant location by a user. Also the portable computing device includes or more targeting tools for aid in targeting a distant location by the user. For example the portable computing device may include a laser pointer or a digital camera for use in targeting as will be described in more detail later in this document. The portable computing device also includes a user interface component such as a button, knob, switch, lever, or trigger that the user manipulates so as to indicate that the portable computing device is then currently aimed at a desired distant location.

As shown in FIG. 2, one embodiment of a targeting location-information-system 100. The targeting location-information-system 100 includes a portable computing device 110 such as a personal digital assistant (PDA) or cell phone or portable gaming system or portable media player configured with the appropriate hardware and software to support the current embodiments. As shown in the figure, the system includes a GPS receiver 120 and a radio transmitter/receiver, e.g., transceiver 130, and one or more orientation sensors such as a magnetometer (not shown) and an accelerometer (not shown). The GPS receiver 120 receives signals from three or more GPS transmitters 200 and converts the signals to a specific latitude and longitude (and in some cases altitude) coordinate as described above. The GPS receiver 120 provides the coordinate to the software running upon portable computing device 110. The orientation sensors provide orientation data to software running upon the portable computing device 110, said orientation data indicating the direction at which the portable computing device is pointing when aimed at a distant location by the user. Additional targeting technology may be included, said targeting technology used to assist the user in aiming said targeting location-information system at a remote target as required by the inventive methods disclosed herein.

In the embodiment shown, element 115 is a targeting tool such as digital camera or integrated laser pointer as will be described in more detailed later in this document. As described previously, a multi-step triangulation process is used to accurately identify a distant location or distant area or distant volume that is some distance from the user. Software running upon the portable computing device computes a coordinate or set of coordinates for the desired distant location or distant area or distant volume. As described previously in more detail, said coordinate or coordinates are computed in software running upon said portable computing device. The software process operates by finding the best-fit intersection point of a plurality of mathematically defined infinite lines, said infinite lines being defined by data collected under the direction of the user as he or she performs a multi-step targeting process. More specifically, each of said infinite lines extends from one of a plurality of different local locations from which the user targeted the desired distant location and passes through the distant location that was aimed at by the user during targeting. Each of the infinite lines is defined by a set of positional coordinate (such as a GPS coordinate) and a directional vector for each of said local locations. Each of said directional vectors points from its respective local location to the distant location that was aimed at by the user when he or she was standing at that local location. The best-fit intersection point of said plurality of infinite lines is then computed by software running upon said portable computing device.

Many different mathematical techniques may be used to find this best-fit intersection point. The best-fit intersection point is defined as a point that represents the location where the group of lines come nearest to intersecting. In one technique the best-fit intersection point is computed as that point which is the shortest equidistant span away from each of said group of infinite lines. When there are only two infinite lines, this is computed by first finding the shortest line-segment that connects the two infinite lines and then by finding the midpoint of that line-segment. One standard method of finding the shortest line segment connecting the two lines is the shortest line segment that can be drawn connecting the two lines will be that line segment which is perpendicular to both. This can be solved using standard vector algebra and employing the vector cross-product to solve for the line segment that is perpendicular to both of said two infinite lines. Once this line segment is found, the coordinate of its midpoint can be found using basic geometric relations. This coordinate will be the best-fit intersection point.

An alternate way of computing the best-fit intersection point for two infinite lines is to define an infinitely long cylinder centered around each of said infinite lines, the cylinders having a radius r and extending along the length of said infinite lines. Through computation or iteration, the smallest r is then solved such that the two cylinders are tangent to each other at a single point in space. This point in space is the best-fit intersection point. Other techniques can be used for more than two lines. Some of said technique use statistically averaging methods to interpolate a best-fit intersection point among numerous possibilities. In one technique a plurality of infinitely long cylinders of equal radius are defined such that each is centered around one of said infinite lines and extends along the length of that infinite line. A volume of intersection is then solved for said plurality of cylinders. The centroid of said volume is then computed and used to represent the best-fit intersection point for said plurality of infinite lines. In one such technique the radius used for said cylinders is the smallest radius such that each of said plurality of cylinders intersects with all others. In some embodiments, mathematical techniques are used to weight the importance of some of said plurality of infinite lines over the importance of other of said plurality of infinite lines when computing said best-fit intersection point. Such weighting is typically used as a means of reducing the impact of outliers or erroneous readings upon the resulting best-fit intersection point.

Regardless of how it is computed, the best-fit intersection point is generally represented as a spatial location, preferably a set of GPS coordinates, referred to herein as distant target coordinates. Information associated with said distant target coordinates is then transmitted to the computer 110 via the transceiver 130 (i.e., by either a radio network or other wireless or wire communication link) and displayed on the display 140. In the event that numerous pieces of information are associated with the distant target coordinates, the information that is displayed may be dependent upon additional prioritization information or how the information is displayed (i.e. the order the numerous pieces on information are displayed) may be dependent upon additional prioritization information.

In addition, the user may select a TARGETING CONTEXT and/or TARGETING OBJECT TYPE when pointing at a location and requesting information. When a TARGETING CONTEXT and/or TARGETING OBJECT TYPE is selected by the user, only information of that TARGETING CONTEXT and/or TARGETING OBJECT TYPE is displayed to the user on the display of said portable computing device. For example, if the user is pointing at a location that contains numerous pieces of information and selects a TARGETING CONTEXT of “Educational”, only information of CONTEXT TYPE “Educational” will be displayed. Similarly, if the user is pointing at a location that contains numerous pieces of information and selects a TARGETING OBJECT TYPE of “foliage”, only information of OBJECT TYPE “foliage” will be displayed. In this way the user can point at a remote location that may be crowded with diverse information and only review that information of a desired CONTEXT TYPE and/or OBJECT TYPE.

Information about various locations is organized and stored on the distributed network and is preferably organized as “web pages.” A plurality of different web pages or other web-based information segments may be associated with the same or similar locations. Said web pages may also contain data that associates the information with one or more OBJECT TYPES and one or more CONTEXT TYPES. An OBJECT TYPE associates information with a particular type of object that resides at the particular location. Example OBJECT TYPES include trees, plants, landforms, bodies of water, residences, businesses, parks, outcroppings of rock, natural landmarks, manmade landmarks, sports fields, streets, bridges, tunnels, stores, restaurants. A CONTEXT TYPE associates information with a particular context of inquiry that the user may be engaged in. Example CONTEXT TYPES include consumer, educational, historical, or natural. The web pages or pointers to the web pages or other web-based information segments are preferably stored on the predetermined node 300 of the distributed network 305. However, the web pages may also be stored at various other nodes on the distributed network 305 and may be associated with one or more location coordinate corresponding to physical locations. The web pages may have, for example, an already existing URL, e.g., a proprietary pre-existing URL. Alternatively, coordinate information may be incorporated into an existing URL to form a unique URL. Further, the coordinate may also be the entire URL of the web pages. A client, either local or remote, may access the web pages preferably via a server on the predetermined node 300 of the distributed network 305.

In some embodiments, the targeting-location-information-system 100 transmits, via the transceiver 130, the GPS coordinates embodied within or represented by said distant target coordinates directly to the predetermined node 300 of the distributed network 305 having the web pages associated with those coordinate (or associated with a location that falls within the range defined by those coordinates) residing thereon. In this case, the web pages and the associated coordinates are stored on the same node of the distributed network 305. Alternatively, the web pages and the associated coordinates may be stored on separate nodes of the distributed network 305.

In embodiments when the location coordinates are provided on a separate node distinct from the node or nodes storing the corresponding web pages, the targeting-location-information-system 100 provides a reference page on the predetermined node 300 of the distributed network 305. The reference page provides a “hyperlink” to a web page or pages located on separate nodes. In the case when the web page is located on a separate node, a directory list of names of all web pages associated with particular coordinates (or ranges of coordinates) may be stored on the predetermined node 300. The directory page may then access the directory list in order to determine whether the web page associated with a particular coordinate (or range of coordinates) resides on another node of the distributed network 305. In some embodiments the computer 110 transmits the hyperlink string and receives the web pages via the transceiver 130. The corresponding web pages residing on a separate node of the distributed network 305 may also be directly accessed from the predetermined node 300 and downloaded to the computer 110 via the radio transceiver 130 without the use of the hyperlinks. In some embodiments this may be provided by a common gateway interface script (CGI), as discussed below. The corresponding web pages provide the user with specific information associated with the coordinates (or range of coordinates) representing that location (or range of locations).

A directory page associated with several coordinate or ranges of coordinates may be retrieved from the distributed network 305 as discussed above. The directory page may list several web pages associated with particular coordinates (or ranges of coordinates) and provide links to the associated web pages. The retrieved web pages may provide location specific information related to those particular locations as designated by said coordinates or ranges of coordinates. The GPS receiver 120 of the targeting location-information system 100 is can be, for example, a PCMCIA Pathfinder Card (with associated hardware and/or software) manufactured by Trimble Navigation Ltd., Sunnyvale, Calif., for receiving information from the GPS transmitters 200. The GPS receiver 120 may be integrated directly into the portable computing device and not be an extractable card. The radio transceiver 130 of the targeting location-information system 100 can be a cellular modem radio or other wireless link. The radio transceiver 130, for example, may work with a Ricochet Wireless Network system from Metricom. The radio transceiver 130 may also comprise other systems, such as, for example, a cellular digital packet data (CDPD) type radio transceiver. The radio transceiver 130 may also, for example, be a Bluetooth wireless communication connection.

As described above, the coordinates may be referenced to a URL residing on the predetermined node 300. The web page 310 may have a unique pre-existing URL, such as, for example, http://www.remotelocation.com, or may use the coordinate as part of the URL, such as, http://www.remotelocation.com/coordinates/<lat>/<long>/<alt> where <lat> is the latitude and <long> is the longitude and <alt> is the altitude. In some embodiments the altitude variable is not used. The coordinate entry may alternately be referenced to the directory page on the predetermined node 300 which links to an existing web page on a separate node of the distributed network 305.

Because web based information can be stored with associated coordinates of varying levels of resolution, an important aspect of the present embodiments is the ability to access web information with associated coordinates that are within certain proximity of said distant target coordinates and/or have associated coordinates that fall within a range defined by said distant target coordinates. In this way an exact match is not needed between said Distant Target Coordinates and the coordinates associated with a given piece of information to access that information by the remote targeting methods described herein. Also in this way small errors in remote targeting and/or in GPS sensing can be accommodated for. In this way the user can point in the direction of a desired location and receive information about that location even if the targeting accuracy is not perfect so long as the coordinates of that location are within a defined proximity of the Distant Target Coordinates or fall within a range of coordinates defined by the Distant Target Coordinates. In the preferred embodiment the user can set the defined proximity of acceptable targets by accessing a menu driven interface upon said portable computing device. In a simple embodiment, for example, can define the proximity as 10 feet, thereby accessing all web links with coordinates that fall within 10 feet of the Distant Target Coordinates.

A problem with this simple method is that when the portable computing device is aimed at something near, the 10 foot proximity may be too large an area, and when the portable computing device is aimed at something very far, the 10 foot proximity may be too small of an area. To solve this problem a more advanced method has been developed wherein the acceptable proximity is a percentage of the computed distance to the desired distant location. The percentage can be set by the user using a menu driven interface upon said portable computing device. For example the user can define the proximity as 20% of the distance to the desired distant location. In this way when the user is pointing at a remote location that is, for example, 10 feet away, any information with associated coordinates that falls within a 2 foot proximity of the Distant Target Coordinates is accessed and displayed to the user (except when excluded by priority, target context type, or target object type as described previously). Also, when the user is pointing at a remote location that is, for example, 80 feet away, any information with associated coordinates that fall within a 16 foot proximity of the Distant Target Coordinates is accessed and displayed to the user (except when excluded by priority, context type, or target object type as described previously). In an even more advanced embodiment instead of a simple percentage, which is a linear relationship between proximity size and distance to the target location, non-linear relationships can be used.

In other embodiments the user can control a roller, knob, or other user interface control upon said portable computing device to vary in real-time the defined proximity. In this way the user can expand and/or contract the defined proximity while viewing the information that is displayed for various proximities, thereby interactively finding for himself or herself a desired proximity for his current information retrieval action.

Software Control:

In preferred embodiments of the software control routines implemented by the portable computing device, positional coordinates and directional vector data is derived from sensors and stored in local memory upon user input indicating that the portable computing device is properly aimed at a desired distant location (or area). This targeting step is repeated by said user a plurality of times so as to perform the multi-step triangulation process disclosed herein. Each time the targeting step is performed, an additional set of positional coordinates and directional vector data is stored in memory. Once the user is finished performing targeting steps, the user engages the user interface once again, indicating this time that location related data for the desired distant location (or area) should be retrieved. The software control routines now access said multiple sets of positional coordinates and directional vectors and computes a best-fit intersection point as described previously. Based upon these computations, distant target coordinates are computed and transmitted to the distributed network 305.

In one such embodiment, the portable computing device includes two physical controls that are manually engaged by the user, for example a first button and a second button. The first button is a targeting button. The second is an access information button. Using these two physical controls, the user moderates the software flow described in the previous paragraph as follows: The user decides that he or she wants information about a desired distant location, so he aims his or her portable computing device (or a portion thereof) as the desired distant location. During this step the user may engage a targeting tool (for example depressing lever that turns on a laser pointer that indicates where in the distance the user is aiming the portable computing device or portion thereof). Once the user is satisfied with his or her aim upon the desired distant location, he or she presses the targeting button. Upon the button press, the software control routines read the positional sensors (i.e. GPS sensors) and derive a set of current positional coordinates. The software control routines also read the directional sensors (i.e. magnetometer and/or accelerometer sensors) and derive directional vector data for the then current aiming direction of the portable computing device (or portion thereof). This positional coordinate data and directional vector data is then stored in memory as a first set of data. The user then walks to a new local location in the environment. This may involve walking a few yards forward down a path. The user then retargets the same desired distant location from this new local location. To do this, the user aims his or her portable computing device (or a portion thereof) as the desired distant location. During this step the user may again engage a targeting tool (i.e. turn on a laser pointer that indicates where in the distance the user is aiming). Once the user is satisfied with his or her aim upon the desired distant location, he or she presses the targeting button again. Upon this second button press of the targeting button, the software control routines read the positional sensors (i.e. GPS sensors) again and derive a new set of current positional coordinates. The software control routines also read the directional sensors (i.e. magnetometer and/or accelerometer sensors) again and derive new directional vector data for the then current aiming direction of the portable computing device (or portion thereof). This positional coordinate data and directional vector data is then stored in memory as a second set of data. The user can optionally walk to additional locations and press the targeting button again in order to achieve more accurate targeting. In this particular case the user does not, instead pressing said access information button, indicating that location associated data for the desired distant location (or area) should be retrieved. The software control routines now access the first and second sets of positional coordinates and directional vectors and computes a best-fit intersection point as described previously. Based upon these computations, distant target coordinates are computed and transmitted to the distributed network 305. Based upon said distant target coordinates, data is displayed to said user upon the portable computing device that is related to the desired distant location (or area).

In some embodiments, all information linked to the distant target coordinates are accessed and displayed to the user. In other embodiments all information that is linked to coordinates that fall within a certain proximity of the distant target coordinates are accessed and displayed to the user. In other embodiments all information that is linked to coordinates that fall within a particular area defined by said distant target coordinates are accessed and displayed to the user. In some embodiments the user may select through the user interface which of these embodiments is implemented upon his or her portable computing system. In some embodiments, the displayed information is limited ONLY to information that matches some search criteria and/or is above some defined priority level. In this way the user can limit the information that is displayed to ONLY information that is relevant to the user's then current information search and/or ONLY to information that is of high enough priority level. As described previously, the search criteria could be a TARGET CONTEXT TYPE and/or a TARGET OBJECT TYPE that defines the context within which the user is searching for information and/or the type of object about which the user is searching for information respectively.

One aspect of the present embodiments is the ability of a user of a portable computing device to target a remote location, multiple times, and gain information about that location and/or about objects that reside at that location. As described herein, the hardware employed by the current embodiments incorporates position sensor technology such as GPS that tracks the geographic location of the portable computing device as carried about by the user. As also herein the hardware employed by the current embodiments incorporates orientation sensor technologies such magnetometers and accelerometers that track the orientation of the portable computing device, the orientation indicating the direction that said portable computing device (or a portion thereof) is pointing as held by the user. The magnetometer and accelerometers can determine the spatial orientation with respect to magnetic north as well as the spatial orientation with respect to the downward direction due to gravity. In this way the software running upon said portable computing device can determine not only where the user is in the world (based upon position data collected by said GPS sensors) at particular points in time, but also what direction the user is pointing at (based upon orientation sensor data) as the user manipulates the portable computing device (or a portion thereof) and aims it at a desired target. This action by the user of aiming the portable computing device (or a portion thereof) at a particular remote target is referred to herein as Targeting and involves the user pressing a button or otherwise manipulating a user interface to indicate that the portable computing device is then aimed at a remote target about which information should be accessed off the Internet.

There still remains a need for additional methods and apparatus to enable a user to accurately aim the portable computing device (or a portion thereof) at a particular remote location and press the button (or otherwise manipulate said user interface) to indicate that the portable computing device is then aimed at a particular remote target about which information should be accessed. This is because it is difficult for a user to know with significant accuracy how well he or she is aiming the portable computing device (or a portion thereof) at a particular remote location that is some distance away from where the user is standing. In addition there may be many different objects and/or many different locations in close proximity that a user might target and so increased accuracy will greatly facilitate a user's ability to gain desired information by targeting remote locations. To satisfy this need a number of methods and apparatus have been developed that facilitate targeting. These methods are described with respect to a preferred embodiment—a portable computing device that is a handheld unit that can be aimed at a remote location by the user. The same methods can be implemented in other physical embodiments, including but not limited to wrist worn embodiments and head mounted embodiments. Also, some embodiments may employ multiple targeting tools that can be used simultaneously or can be selectively switched between. Finally, some embodiments or some modes of some embodiments may not employ any targeting tools beyond providing a portable computing device (or portion thereof) that is purposefully shaped such that a user can easily point a designated portion of said portable computing device in the direction of a desired distant location.

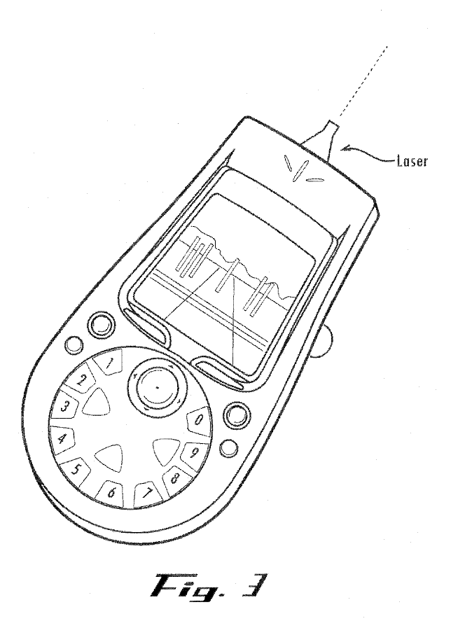

As shown in FIG. 3 an embodiment is illustrated including a laser pointer. As shown in the figure, a laser pointed is incorporated within the portable computing device (or a portion thereof) such that it is aligned along the aiming direction of the portable computing device (or the aimable portion thereof). The laser pointer is used in a method to enhances a user's ability to target a remote location. The laser pointer included within the casing of said portable computing device is configured such that when the portable computing device is at a remote location, said laser pointer shines in the aiming direction. A lever, button, or other user manipulatable interface is included upon the portable computing device such that the user can selectively activate said laser pointer. When the laser pointer is on the user can see an illuminated dot indicating where the portable computing device is then currently aimed. This illuminated dot serves as a highly valuable reference for said user such that the user can move the portable computing device around in his hand, changing its orientation in space, until said illuminated dot is shining upon the desired target location. The user can then press another button (or otherwise interact with the user interface of the portable computer system) to indicate that the desired aiming has been achieved (i.e. a targeting button). The portable computing device then reads the position sensors and orientation sensors and stores data as described previously.

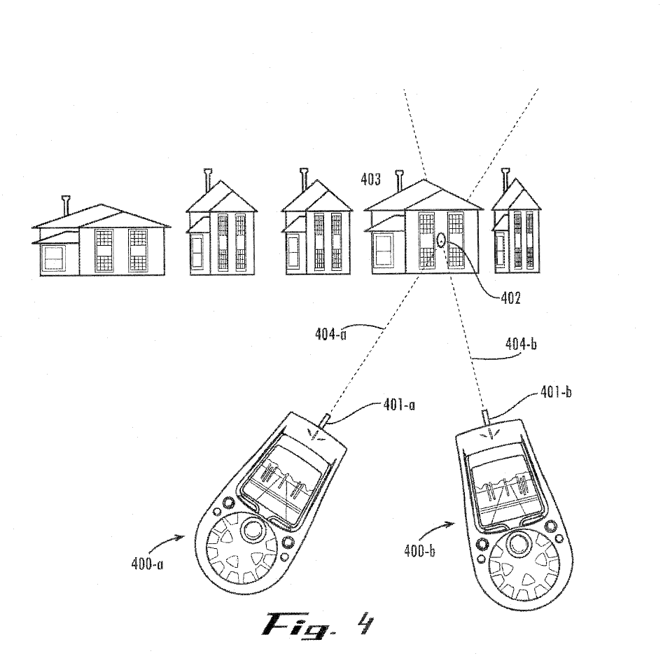

As shown in FIG. 4, a handheld portable computing device 400 is equipped with a GPS sensor for tracking its position. Also included is one or more orientation sensors for tracking the direction the handheld portable computing device is aimed by the user who is holding it. The figure shows this device in two different positions and orientations as it would be held by the user in two subsequent steps of the multi-step triangulation process. Elements of the device when shown in said first position and orientation are labeled with an (a). Elements of the device when shown in said second position and orientation are labeled with a (b). Thus the portable computing device 400-a is held by said user at said first position and orientation and the portable computing device 400-b is the same unit, but is held by said user at a second position and orientation.

Also included and shown in the figure as element 401 is an integrated laser pointer for projecting a red dot 402 upon objects that fall within the line-of-sight aiming direction of the portable computing device. The laser beam is represented by dotted line 404 and projects as a straight line along the direction of aiming. In this figure the user aims the portable computing device at one of five houses that are visible to the user, using the laser pointier to aid in the aiming process. By watching the location of the red dot 403 the user knows where he is aiming the portable computing device as he or she changes the orientation. Again, the user perform the targeting step twice, first targeting the house with laser beam 404-a and then targeting the same house from said different position and orientation with laser beam 404-b. While only two steps is shown, in some embodiments the user may perform this step more than twice.

At each step in the multi-step targeting effort, once the portable computing device is aimed at the desired target 403 which is the forth house from the left in the figure, the user presses a targeting button (or otherwise engages the user interface on the portable computing device), causing the software routines to derive and store in memory data representative of the then current position and orientation of said portable computing device. Thus in this example, two sets of data are stored—one set of data for when the user targets the house 403 from location 400-a using laser beam 404-a to aid in targeting. And one set of data for when the user targets the house 403 from location 400-b using laser beam 404-b to aid in targeting. Once both targeting steps have been performed, the user presses an access information button (or otherwise engages the user interface on the portable computing device), causing the software routines to compute a set of distant target coordinates for said house 403. The software routines then access information from the internet that relate to or are associated with said distant target coordinates. This information accessed is displayed to the user on the screen of said portable computing device or optionally played as audible information over a speaker or headphone on the portable computing device. If the house is a residence, the information includes, for example, the names of the people who live in the house. If there is a business within the house the information includes, for example, the name of the business and a description of the products or services of the business. If the house is a historical landmark, the information includes, for example, historical information about the house.

It should be noted that the portable computing device includes, in preferred embodiments, a user interface button or other manipulatable interface for turning on the laser pointer at desired times. The user will use this button to turn on the laser pointer only when he or she desires aid in aiming the portable computing device at a desired target.

It should also be noted that in many cases the size of the target area is substantially larger than the size of the dot displayed by the targeting aid. In some embodiments the targeting aid also depicts the size of the targeting area by displaying multiple dots or other projected images. For example, three dots can be projected to outline a triangle that roughly estimates the size of the targeting area. Similarly, the laser beam can be shaped by lenses into a ring shape that roughly estimates the size of the targeting area.

A second method enhances a user's ability to target a remote location by including a digital video camera within the casing of said portable computing device (or a portion thereof that also includes positional and directional sensors) such that when the portable computing device (or a portion thereof) is aimed at a remote location, said camera captures an image in the aiming direction, said image being displayed upon the screen of said portable computing device, said image depicting that part of the real physical space which is being aimed at by the user. Thus by watching the displayed image on the screen, the user knows where he is aiming the portable computing device as he or she changes the orientation. In some embodiments everything that is displayed upon the screen falls within the desired distant area being aimed at within the real physical space. In other embodiments, a point on the image at the center of the screen (or near the center) is that location that is being aimed at in the real physical space. In such embodiments graphical crosshairs can be optionally overlaid upon the displayed image to indicate the point on the image that is being aimed at within the real physical space. In other embodiments a particular area of the image on the screen is the area of locations that is being aimed at in the real physical space. In such embodiments a graphical image depicting the selection area (such as a box or a circle or a shaded region) may be optionally overlaid upon the displayed image to indicate the area on the image that is being aimed at within the real physical space.

Also, the size of the selection area (for example the size of the box or circle or shaded region) can be optionally controlled by the user through the user interface on said portable computing device. By changing the size of the selection area said user can change the size of the desired distant area for which information is requested. For example if the user sets the size of the area to be large, data is sent to the network as part of the information retrieval process that represent a large area. But if the user sets the size of the area to be small, data is sent to the network as part of the information retrieval process that represents a small area. Alternatively, if the user sets the size of the selection area to be large, the software retrieves location related information within a larger proximity of the desired distant location than if the user sets the size of the selection area to be small.

A button or other user manipulatable interface is included upon the portable computing device such that the user can selectively activate the digital camera such that the image of the remote location being aimed at is displayed. This displayed image serves as a valuable reference for the user such that the user can move the portable computing device around, changing its orientation in space, until the image includes the desired distant location. The user can then press another button (or otherwise interact with the user interface of the portable computer system) to indicate that the desired aiming has been achieved. The portable computing device then reads the positional sensors and directional sensors to determine the positional coordinates and directional vector for that particular targeting step as described previously.

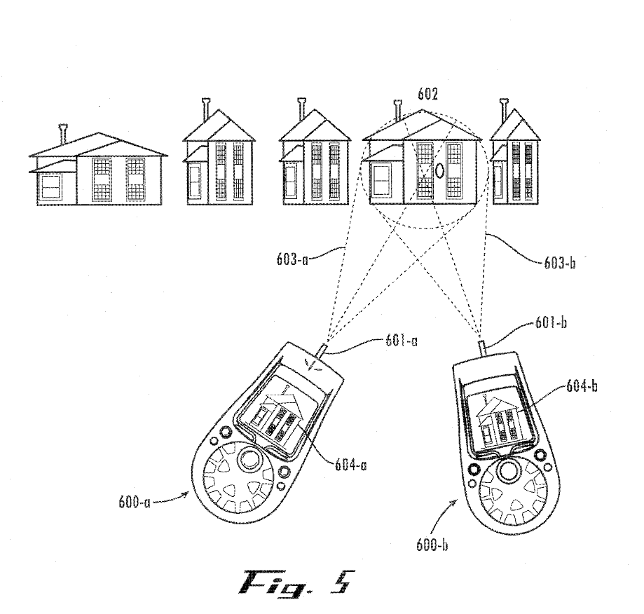

FIG. 5 shows a handheld portable computing device equipped with a GPS sensor for tracking its position. Also included is one or more orientation sensors for tracking the direction the portable computing device is aimed by the user who is holding it. The figure shows this device in two different positions and orientations as it would be held by the user in two subsequent steps of the multi-step triangulation process. Elements of the device when shown in the first position and orientation are labeled with an (a), while elements of the device when shown in said second position and orientation are labeled with a (b). Thus the portable computing device 600-a is held by the user at the first position and orientation and the portable computing device 600-b is the same unit, but is held by the user at a second position and orientation.

Also shown is an integrated digital video camera 601-a, 601-b for capturing an image in the direction that the portable computing device is aimed by the user. The dotted lines 603-a, 603-b in the figure indicate the field of view of the camera as determined by the optics and how the portable computing device is aimed by the user. The captured image 604-a, 604-b is displayed upon the screen of said portable computing device showing the user what is being aimed at and thereby assisting in the targeting process. By watching the displayed image, the user knows where he is aiming the portable computing device as he or she changes the orientation. Thus when the portable computing device 600-a is held in the first position shown, it captures and displays image 604-a as a result of camera 601-a being pointed in the direction depicted by dotted lines 603-a. When the image shows the desired target location (in this case house 602), the user knows the device is appropriately aimed from said first position at house 602. Similarly, when the portable computing device 600-b is held in the second position shown, it captures and displays image 604-b as a result of camera 601-b being pointed in the direction depicted by dotted lines 603-b. When the image shows the desired target location (in this case house 602, the user knows the device is appropriately aimed from said second position at house 602. Thus the camera assists the user in each of a plurality of distinct targeting acts, each of said targeting acts being performed from a different local location. Cross hairs or other graphics may be overlaid upon the displayed image to further assist the user in accurate targeting.

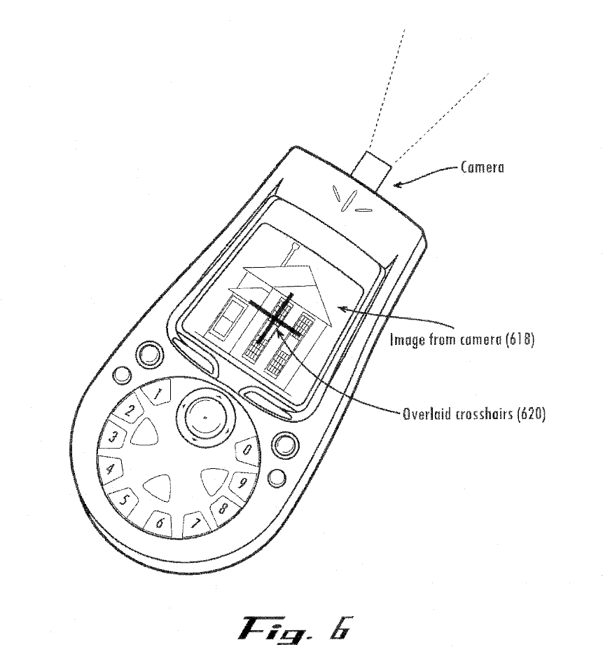

Referring to FIG. 6 we see a portable computing device embodiment includes a camera 616 used as a targeting tool. The image 618 captured by said camera is displayed upon the screen of said portable computing device such that by looking at the screen, the user can determine within increased accuracy what the portable computing device is aiming at when held at a particular position and in a particular orientation. Furthermore, this embodiment includes an image of crosshairs 620 overlaid upon the image 618 from said camera to further assist the user in targeting. The crosshairs indicate to the user the center of the region being aimed at by the user when pointing said portable computing device. In other embodiments said crosshairs can be replaced by other overlays such as graphical circles, boxes, or other marks or regions or areas to further inform the user about what is being aimed at when the portable computing device is pointed in a particular direction.

Referring to FIG. 5, at each step in the multi-step targeting effort, once the portable computing device is aimed at the desired target 602, the user presses a targeting button (or otherwise engages the user interface on the portable computing device), causing the software routines to derive and store in memory data representative of the then current position and orientation of said portable computing device. Thus in this example, two sets of data are stored—one set of data for when the user targets the house 602 from location 600-a using camera image 604-a to aid in targeting. And one set of data for when the user targets the house 602 from location 600-b using the camera image 604-b to aid in targeting. Once both targeting steps have been performed, the user presses an access information button (or otherwise engages the user interface on the portable computing device), causing the software routines to compute a set of distant target coordinates for said house 602. The software routines then access information from the internet that relate to or are associated with said distant target coordinates. This information accessed is displayed to the user on the screen of said portable computing device and/or optionally played as audible information over a speaker or headphone on the portable computing device. If the house is a residence, the information includes, for example, the names of the people who live in the house. If there is a business within the house the information includes, for example, the name of the business and a description of the products and/or services of the business. If the house is a historical landmark, the information includes, for example, historical information about the house.

An optical or digital zoom feature (not shown) can be employed within the digital camera embodiment described in the paragraphs above. Such an optical and/or digital zoom can allow the user to zoom-in or zoom-out with the camera and thereby change the field of view displayed upon-the screen. By changing the displayed field of view by adjusting said optical or digital zoom, the user changes the size of the desired distant area for which information is requested. For example if the user zooms out, a large range of distant target coordinates are sent to the network as part of the information retrieval process. But if the user zooms-in, a small range of distant target coordinates are sent to the network as part of the information retrieval process. Alternatively, if the user zooms-out, the software retrieves location related information within a larger proximity of the desired distant location than if the user zooms-in.

This invention has been described in detail with reference to a number of preferred and alternate embodiments. It should be appreciated that the specific embodiments described above are merely illustrative of the principles underlying the inventive concept. It is therefore contemplated that various modifications of the disclosed embodiments will, without departing from the spirit and scope of the invention, be apparent to persons of skilled in the art.

What is claimed is:

1. A method for using a portable computing device to retrieve information relationally associated with a distant location within a physical environment, the method comprising:
collecting a first set of geospatial sensor data when said portable computing device is positioned at a first local location and aimed at said distant location, said first set of geospatial sensor data including a first positional coordinate and first directional vector;
collecting a second set of geospatial sensor data when said portable computing is positioned at a second local location and aimed at said distant location, said second set of geospatial sensor data including a second positional coordinate and second directional vector;
computing locative coordinates representing said distant location, said locative coordinates computed based at least in part upon both said first set of geospatial sensor data and said second set of geospatial sensor data;
accessing information from a remote server using a representation of said locative coordinates having been computed, said information from said remote server being relationally associated with said distant location; and
displaying a representation of said information having been accessed upon a display component of said portable computing device.

2. A method as recited in claim 1 wherein said first positional coordinate represents a location of said portable computing device at said first local location and wherein said first directional vector points in a direction from said first local location towards said distant location

3. A method as recited in claim 1 wherein said second positional coordinate represents a location of said portable computing device at said second local location and wherein said second directional vector points in a direction from said second local location towards said distant location

4. A method as recited in claim 1 wherein said locative coordinates define at least one of a point, an area, or a volume.

5. A method as recited in claim 1 wherein said computing of said locative coordinates is performed at least in part by finding a best-fit mathematical intersection of a first line extending from said first local location along said first directional vector with a second line extending from second local location along said second directional vector.

6. A method as recited in claim 1 wherein said computing of locative coordinates is performed at least in part by finding at point at or near a midpoint of a shortest line segment connecting of a first line extending from said first local location along said first directional vector with a second line extending from second local location along said second directional vector.

7. A method as recited in claim 1 wherein said computing of locative coordinates is performed at least in part by finding a mathematical intersection of a first cone extending from said first local location along said first directional vector with a second cone extending from second local location along said second directional vector.

8. A method as recited in claim 1 wherein said computing of locative coordinates is performed at least in part by finding a mathematical intersection of a first volume extending from said first local location along said first directional vector with a second volume extending from second local location along said second directional vector.

9. A method as recited in claim 1 wherein said computing of locative coordinates is performed at least in part by finding a mathematical intersection of a first plane extending from said first local location along said first directional vector with a second plane extending from second local location along said second directional vector.

10. A method as recited in claim 1 wherein said computing of locative coordinates is performed at least in part by finding a mathematical intersection of a first line, plane, or volume extending from said first local location in a direction along said first directional vector with a second line, plane, or volume extending from second local location in a direction along said second directional vector.

11. A method as recited in claim 2 wherein said first positional coordinates is collected at least in part by reading data from a GPS transducer local to said portable computing device.

12. A method as recited in claim 2 wherein said first directional vector is collected at least in part by reading data from a magnetometer local to said portable computing device.

13. A method as recited in claim 1 wherein said steps of collecting, computing, accessing, and displaying are performed in at least in part by one or more microprocessors local to said portable computing device.

14. A method as recited in claim 1 wherein said method further includes collecting a third set of geospatial sensor data when said portable computing is positioned at a third local location and aimed at said distant location, said third set of geospatial sensor data including a third positional coordinate and third directional vector and wherein said locative coordinates are computed based at least in part upon said third set of geospatial sensor data in addition to said first set of geospatial sensor data and said second set of geospatial sensor data.

15. A method as recited in claim 1 wherein each said collecting step is performed in response to signal received from a user manipulatable object that is triggered in response to a user finger motion.

16. A method as recited in claim 15 wherein said user manipulatable object is one of a button, trigger, lever, knob, or switch.

17. A method as recited in claim 1 wherein said portable computing device includes a user aiming portion that aids said user in pointing said portable computing device at said distant location.

18. A method as recited in claim 1 wherein said aiming portion is a specially shaped portion and/or marking upon said casing.

19. A method as recited in claim 1 wherein said aiming portion includes a laser pointer.

20. A method as recited in claim 1 wherein said aiming portion includes a digital camera pointed away from said portable computing device in the direction of aiming.

21. A method as recited in claim 20 wherein said portable computing device includes a display for presenting the image captured by said digital camera.

22. A method as recited in claim 21 wherein said display is integrated into the casing of the portable computing device.

23. A method as recited in claim 1 wherein a plurality of pieces of information are accessed from said remote server that are relationally associated with said distant location.

24. A method as recited in claim 23 wherein said plurality of pieces of information are filtered based upon one or more object types relationally associated with one or more of said pieces of information.

25. A method as recited in claim 23 wherein said plurality of pieces of information are filtered based upon one or more context types relationally associated with one or more of said pieces of information.

26. A method as recited in claim 1 wherein only pieces of information that are of one or more user defined object types are accessed from some remote server.

27. A method as recited in claim 1 wherein only pieces of information that are of one or more user defined context types are accessed from some remote server.

28. A method as recited in claim 4 wherein said locative coordinates define an area, the size of which is controllable by a user of said portable computing device.

29. A method as recited in claim 4 wherein said locative coordinates define an volume, the size of which is controllable by a user of said portable computing device.

30. A method as recited in claim 29 wherein said volume is a sphere.

31. A method as recited in claim 1 wherein said accessing is performed by wireless communication between said portable computing device and said server over a network.

32. A method as recited in claim 1 wherein said displaying includes the display of a plurality of pieces of information accessed from said server, the order of the display of said plurality of pieces of information being dependent upon their relative proximity to a central point of said locative coordinates.

33. A multi-step triangulation method for using a portable computing device to retrieve information that is relationally associated with a distant location within a physical environment, the method comprising:
collecting a first set of geospatial sensor data when said portable computing is positioned at a first local location and is aimed at said distant location, said first set of geospatial sensor data including a first positional coordinate representing a current location of said portable computing device and a first directional vector representing a current orientation of said portable computing device, said first set of geospatial sensor data being collected in response to user input to said portable computing device;
collecting a second set of geospatial sensor data when said portable computing is positioned at a second local location and is aimed at said distant location, said second set of geospatial sensor data including a second positional coordinate representing a current location of said portable computing device and a second directional vector representing a current orientation of said portable computing device, said second set of geospatial sensor data being collected in response to user input to said portable computing device;
computing locative coordinates representing said distant location, said locative coordinates computed based at least in part upon a geometric calculation using both said first set of geospatial sensor data and said second set of geospatial sensor data, said locative coordinates defining at least one of a point, an area, or a volume at said distant location;
accessing information from a remote server using a representation of said locative coordinates having been computed, said information being relationally associated with said distant location;
displaying a representation of said information having been accessed upon a display component of said portable computing device.

34. A method as recited in claim 33 wherein said distant location is a distant area.

35. A method as recited in claim 33 wherein said computing of said locative coordinates involves computing a best-fit intersection point.

36. A method as recited in claim 35 wherein said computing of said accessing of said information involves selecting a piece of information from a server that is relationally associated with a point or area that is at or near said best fit intersection point.

37. A method as recited in claim 35 wherein said computing of said accessing of said information involves selecting a piece of information from a server that is relationally associated with a point or area that is closer to said best fit intersection point than points or areas relationally associated with other pieces of information on said server.

38. A method as recited in claim 33 wherein said second local location is not substantially near said first local location.

39. A method as recited in claim 33 wherein said geometric calculation includes computing a best-fit intersection point.

40. A method as recited in claim 39 wherein said best-fit intersection point is at or near a point that is simultaneously closest to each of two different infinite lines, each of said infinite lines being defined by a positional coordinate and directional vector collected as geospatial sensor data during said multi-step triangulation method.
